(19) United States
(12) Patent Application Publication
(10) Pub. No.: US 2026/0292927 A1
(43) Pub. Date: Sep. 24, 2026

(54) ENHANCEMENTS ON DOWNLINK MONITORING

(71) Applicant: Nokia Technologies Oy, Espoo (FI)

(72) Inventors: Ahlem KHLASS, Massy (FR); Mads LAURIDSEN, Gistrup (DK); Daniela LASELVA, Klarup (DK); Chunli WU, Beijing (CN)

(21) Appl. No.: 19/474,995

(22) PCT Filed: Apr. 18, 2023
(86) PCT No.: PCT/CN2023/089003

§ 371 Date: Oct. 13, 2025

(51) Int. Cl. H04W 76/28; H04W 72/1263

(52) U.S. Cl. CPC H04W 76/28; H04W 72/1263

(57) ABSTRACT

Example embodiments of the present disclosure relate to DL monitoring. An apparatus transmits, to a network device configured with a discontinuous transmission pattern, a first transmission during a non-active period of the discontinuous transmission pattern. The apparatus then starts monitoring at least one monitoring occasion for a second transmission from the network device after a time offset from transmitting the first transmission. In this way, the DL monitoring can be improved by taking cell DTX/DRX pattern into consideration.

### FIELDS

Various example embodiments of the present disclosure generally relate to the field of telecommunication and in particular, to methods, devices, apparatuses and computer readable storage media for downlink (DL) monitoring.

### BACKGROUND

In Rel-18, discontinuous reception (DRX) and/or discontinuous transmission (DTX) are supported in cells for network energy saving. In particular, cell DTX/DRX allows a gNB to turn off, partially or completely, transmission and reception for user data traffic, control signaling, and reference signals during cell DTX/DRX non-active periods. The gNB is then able to enter a sleep state, and thereby saving energy during these non-active periods.

When operating in cell DTX/DRX, a cell may follow a periodic pattern of active and non-active periods. The pattern configuration for cell DRX/DTX is common for UEs in the cell, and separate DTX and DRX patterns may be configured. As a result, it may be possible that the gNB enters a cell DRX active period which is not aligned with a cell DTX active period. Therefore, the DL monitoring mechanism needs to be improved by taking cell DTX/DRX into account.

### SUMMARY

In a first aspect of the present disclosure, there is provided an apparatus. The apparatus comprises at least one processor; and at least one memory storing instructions that, when executed by the at least one processor, cause the apparatus at least to: transmit, to a network device configured with a discontinuous transmission pattern, a first transmission during a non-active period of the discontinuous transmission pattern; and start monitoring at least one monitoring occasion for a second transmission from the network device after a time offset from transmitting the first transmission.

In a second aspect of the present disclosure, there is provided an apparatus. The apparatus comprises at least one processor; and at least one memory storing instructions that, when executed by the at least one processor, cause the apparatus at least to: receive, from a terminal device, a first transmission during a non-active period of a discontinuous transmission pattern; determine at least one transmission occasion starting after a time offset from receiving the first transmission; and transmit, to the terminal device, a second transmission during the at least one transmission occasion.

In a third aspect of the present disclosure, there is provided a method. The method comprises: transmitting, to a network device configured with a discontinuous transmission pattern, a first transmission during a non-active period of the discontinuous transmission pattern; and starting monitoring at least one monitoring occasion for a second transmission from the network device after a time offset from transmitting the first transmission.

In a fourth aspect of the present disclosure, there is provided a method. The method comprises: receiving, from a terminal device, a first transmission during a non-active period of a discontinuous transmission pattern; determining at least one transmission occasion starting after a time offset from receiving the first transmission; and transmitting, to the terminal device, a second transmission during the at least one transmission occasion.

In a fifth aspect of the present disclosure, there is provided a first apparatus. The first apparatus comprises means for transmitting, to a network device configured with a discontinuous transmission pattern, a first transmission during a non-active period of the discontinuous transmission pattern; and means for starting monitoring at least one monitoring occasion for a second transmission from the network device after a time offset from transmitting the first transmission.

In a sixth aspect of the present disclosure, there is provided a second apparatus. The second apparatus comprises means for receiving, from a terminal device, a first transmission during a non-active period of a discontinuous transmission pattern; means for determining at least one transmission occasion starting after a time offset from receiving the first transmission; and means for transmitting, to the terminal device, a second transmission during the at least one transmission occasion.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for a communication process according to some example embodiments of the present disclosure;

FIG. 3 illustrates a schematic diagram of example DTX and DRX patterns according to some example embodiments of the present disclosure;

FIG. 4 illustrates a flowchart of a method implemented at an apparatus according to some example embodiments of the present disclosure;

FIG. 5 illustrates a flowchart of a method implemented at an apparatus according to some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

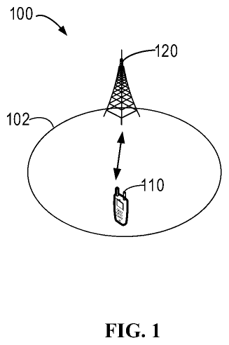

FIG. 1 illustrates an example communication environment 100 in which example embodiments of the present disclosure can be implemented. The communication environment 100 may be a communication network that supports the cell discontinuous reception (DRX)/discontinuous transmission (DTX) mechanism. In the communication environment 100, a first device 110 and a second device 120 may communicate with each other.

The first device 110 may be a terminal device, such as a UE. The second device 120 may be a network device, such as a gNB. In the example of FIG. 1, the first device 110 locates in a cell 102 provided by the second device 120.

In some example embodiments, the second device 120 may operate based on cell DRX/DTX mechanism. The cell DRX/DTX mechanism allows the second device 120 to turn off, partially or completely, transmission and reception for user data traffic, control signaling, and reference signals during cell DTX/DRX non-active periods. Separate DRX and DTX configurations may be applied by the second device 120. In other words, the cell DRX active period may not be aligned with the cell DTX active period.

During the cell DTX/DRX non-active periods, the second device 120 may enter a sleep state. For example, three sleep states are defined for a base station (BS). For each BS category (e.g., cat. 1 and cat. 2), each sleep state may correspond to a transition time (i.e., time need to for the BS to enter and leave a sleep state) and a transition energy (i.e. energy consumed during the transition time for both ramping down and up) as below.

TABLE 1
Example configurations of various sleep states

| | | | | Additional transition | |
|---|---|---|---|---|---|
| | | Total transition | | energy | |
| | | time | | [relative power *ms] | |
| Power state | Characteristic | Cat.1 | Cat.2 | Cat.1 | Cat.2 |
| Deep sleep | There is neither | 50 ms | 10 s | 1000 | 17000 |
| Light sleep | DL transmission | 6 ms | 640 ms | 90 | 1088 |

| | | | |
|---|---|---|---|
| Micro sleep | nor UL reception. | 0 ms | 0 |

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the communication environment 100. It is noted that although illustrated as a terminal device, the first device 110 may be a device other than the terminal device. Moreover, although illustrated as a network device, the second device 120 may be a device other than the network device.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As previously mentioned, the separate DRX and DTX patterns may cause unalignment of the cell DRX active period and the cell DTX active period. This may cause an issue for some procedures initiated by the UE which would require a response from the gNB.

In some mechanisms, for scheduling request (SR) transmission, the UE starts monitoring physical downlink control channel (PDCCH) immediately after sending a scheduling request (SR). However, when the PDCCH monitoring occasions after sending a SR fall in the cell DTX non-active period, it is unclear what the UE behaviour should be after sending an SR. For example, it is unclear whether the UE shall not expect an immediate response from the network device until the following cell DTX active period. In addition, it is unclear whether UE may attempt a SR re-transmission until receiving the network response. This will prolong the procedure and increase the signaling overhead and the UE power consumption.

In some mechanisms, for Random Access (RA) procedure, it is unclear where the UE after the preamble transmission will await for Random Access Response (RAR) from the network.

Additionally, there are similar issues in configured grant (CG) transmission procedure. After transmitting the CG transmissions on physical uplink shared channel (PUSCH), the UE starts monitoring on physical downlink control channel (PDCCH) for a HARQ feedback. If the gNB operates in the DTX non-active period at this time, the monitoring will cause a waste of energy for the UE.

In order to solve at least part of the above problems or other potential problems, a solution on DL monitoring is proposed. With the DL monitoring solution, a first device such as a UE can determine at least one appropriate DL monitoring occasion after transmitting a UL transmission that falls during a cell DTX non-active period. For example, the UE determined at least one DL monitoring occasion starting after a certain time offset. The UE then starts monitoring a feedback or response from a second device such as gNB during the at least one DL monitoring occasion. The time offset may be configured by the gNB or predetermined at the UE. In this way, the issue of the UE monitoring for response/feedback from the cell in cell DTX non-active period after UE has transmitted in uplink can be addressed.

Furthermore, the DL monitoring solution provides rules for allowing the UE to repeat the UL transmission in a case that no feedback or response is received in the least one DL monitoring occasion. For example, a timer for prohibiting retransmission of the UL transmission can be configured or applied. In this way, the network performance and communication reliability can be improved.

Example embodiments of the present disclosure will be described in detail below with reference to the accompanying drawings.

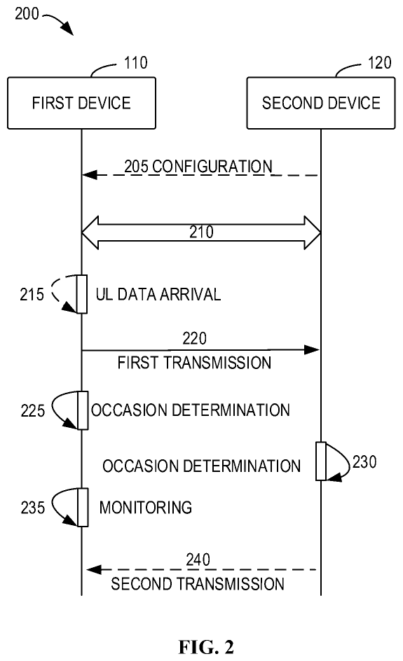

Reference is now made to FIG. 2, which illustrates a signaling chart for a communication process 200 according to some example embodiments of the present disclosure. The process 200 may involve a terminal device (such as, the first device 110) and a network device (e.g., the second device 120). For the purpose of discussion, reference is also made to FIG. 1 to describe the communication process 200.

As previously mentioned, the second device 120 operates based on the cell DTX/DRX mechanism. The second device 120 may transmit 205 the cell DTX/DRX configuration to the first device 110 for indicating the DTX pattern and the DRX pattern. For example, the cell DTX/DRX configuration may indicate active periods and non-active periods of DTX pattern and DRX pattern. The cell DTX/DTX may then be activated 210 in the cell 102.

In some example embodiments, the first device 110 may determine 215 an arrival of UL data, which may later be transmitted as a first transmission. The UL data may be mapped to a certain LCH ID.

The first device 110 then transmits 220 the first transmission during a non-active period of the DTX pattern. The first transmission requires a response or feedback from the second device 120, which may be also referred to as a second transmission hereinafter.

In the context of the present disclosure, the DTX pattern may also be referred to as cell DTX pattern. Further, as used herein, the term “non-active period of the DTX pattern may be referred to as a “cell DTX non-active period”.

In some example embodiments, the first transmission may be a scheduling request (SR). SR may be used for requesting UL grant for a new transmission. The medium access control (MAC) entity may be configured with zero, one, or more SR configurations. Each SR configuration may correspond to one or more logical channels. In such cases, the second transmission may be a configuration of at least one SR resource.

An example of configuration of SR resource may be shown as Table 2 below. The SchedulingRequestConfig may be radio resource control (RRC) configured with parameters for the scheduling request procedure. For example, the information element (IE) SchedulingRequestConfig is used to configure the parameters, for the dedicated SR resources.

TABLE 2
SchedulingRequestConfig information element

-- ASN1START
-- TAG-SCHEDULINGREQUESTCONFIG-START

| | |
|---|---|
| SchedulingRequestConfig ::= | SEQUENCE { |

| | |
|---|---|
| schedulingRequestToAddModList | SEQUENCE (SIZE (1..maxNrofSR-ConfigPerCellGroup)) OF |

SchedulingRequestToAddMod

OPTIONAL, -- Need N

| | |
|---|---|
| schedulingRequestToReleaseList | SEQUENCE (SIZE (1..maxNrofSR-ConfigPerCellGroup)) OF |

SchedulingRequestId

OPTIONAL -- Need N

}

| | |
|---|---|
| SchedulingRequestToAddMod ::= | SEQUENCE { |

| | |
|---|---|
| schedulingRequestId | SchedulingRequestId, |

| | |
|---|---|
| sr-ProhibitTimer | ENUMERATED {ms1, ms2, ms4, ms8, ms16, ms32, ms64, ms128} |

OPTIONAL, -- Need S

| | |
|---|---|
| sr-TransMax | ENUMERATED { n4, n8, n16, n32, n64, spare3, spare2, spare1} |

}

| | |
|---|---|
| SchedulingRequestConfig-v1700 ::= | SEQUENCE { |

schedulingRequestToAddModListExt-v1700 SEQUENCE (SIZE (1..maxNrofSR-
ConfigPerCellGroup)) OF SchedulingRequestToAddModExt-v1700

OPTIONAL -- Need N

}
SchedulingRequestToAddModExt-v1700 ::= SEQUENCE {

| | |
|---|---|
| sr-ProhibitTimer-v1700 | ENUMERATED { ms192, ms256, ms320, ms384, ms448, ms512, |

ms576, ms640, ms1082, spare7, spare6, spare5, spare4, spare3, spare2, spare1}

OPTIONAL -- Need R

}
-- TAG-SCHEDULINGREQUESTCONFIG-STOP
-- ASN1STOP
NR-DL-PRS-ResourceSet-r16 ::= SEQUENCE {

| | |
|---|---|
| nr-DL-PRS-ResourceSetID-r16 | NR-DL-PRS-ResourceSetID-r16, |

| | |
|---|---|
| dl-PRS-Periodicity-and-ResourceSetSlotOffset-r16 | NR-DL-PRS-Periodicity-and- |

ResourceSetSlotOffset-r16,

| | |
|---|---|
| dl-PRS-ResourceRepetitionFactor-r16 | ENUMERATED {n2, n4, n6, n8, n16, n32,...} |

OPTIONAL, -- Need OP

| | |
|---|---|
| dl-PRS-RepforRedCapUE | NR-PRS-RepforRedCapUE |

....

| | |
|---|---|
| NR-PRS-RepforRedCapUE | CHOICE { |

| | |
|---|---|
| Rep2 | BIT STRING (SIZE(2)), |
| Rep4 | BIT STRING (SIZE(4)), |
| Rep6 | BIT STRING (SIZE(6)), |
| Rep8 | BIT STRING (SIZE(8)), |
| Rep16 | BIT STRING (SIZE(16)), |
| Rep32 | BIT STRING (SIZE(32)), |

...

Alternatively, in some other embodiments, the first transmission may be a physical random access channel (PRACH) preamble. In such cases, the communication between the first device 110 and the second device 120 may be a RACH procedure, and the second transmission is a random access response (RAR) message.

Alternatively, in some other embodiments, the first transmission may be a configured grant (CG) transmission on physical uplink shared channel (PUSCH). In such cases, the second transmission may be a HARQ feedback or a retransmission grant for the CG transmission.

It is to be understood that the above examples of the first transmission and second transmission are given only for illustrative purpose, without suggesting any limitation. The first transmission may be any other suitable transmission which requires a feedback or response from the network. For example, if the first device 110 transmits in UL and then monitors for a response in DL, the UL transmission may be considered as the first transmission, and the response as the second transmission. Thus, the present disclosure is not limited in this regard. For the purpose of illustration, in some example embodiments in the following description, the first transmission may be illustrated as a SR transmission.

In some example embodiments, the first device 110 may determine 225 at least one monitoring occasion for the second transmission based on a time offset. The time offset may be in slots or in ms. Accordingly, the second device 120 may determine 230 at least one transmission occasion for transmitting the second transmission. In this case, the at least one transmission occasion is the same as the at least one monitoring occasion determined by the first device 110.

The first device 110 then starts monitoring 235 the at least one monitoring occasion for the second transmission after the time offset from transmitting the first transmission.

The time offset may be configured by the network or predetermined at the first device 110. In the embodiments where the time offset is configured by the network, the second device 120 may transmit a configuration of the time offset. For example, the configuration of the time offset may be contained in the cell DTX/DRX configuration. Alternatively, the configuration of the time offset may be configured separately from the cell DTX/DRX configuration.

In some example embodiments, the time offset may be configured per logical channel (LCH), per SR, per CG, per DTX configuration, per medium access control (MAC) control element (CE), or per UE.

The time offset may be used to wake the second device 120 from the sleep state. In some example embodiments, a value of the time offset may be associated with a transition time from a sleep state of the second device 120 during the non-active period of the DTX pattern to an active state. By way of example, as shown in Table 1 above, for the second device 120 with the cat. 1 type, the transition time is 6 ms from light sleep and 50 ms from deep sleep, respectively. In such examples, the value of the time offset may be greater than the corresponding transition time.

In some example embodiments, a dedicated active period may be configured for the first device 110. The dedicated active period may be partially or fully overlapped with the non-active period of the DTX pattern. As an example, the dedicated active period may start after the time offset from transmitting the first transmission.

In some example embodiments, the second device 120 is allowed to transmit synchronization signal block (SSB) during the non-active period of the DTX pattern. In other words, the cell 102 may be already in the active state for SSB transmission during the non-active period of the DTX pattern, and in this case, the second device 120 may exceptionally perform at least one DL transmission within a certain time period after transmitting the SSB (e.g., a slot after). The time period may be in slots or in ms.

For example, a search space configuration may be used for defining how close the at least one monitoring occasion is to the SSB reception.

Additionally, in the above embodiments, the second device 120 may configure the first device 110 to only monitor the PDCCH within a certain time period after the next SSB, for example, within 4 slots after the end of the SSB transmission.

The time period may be configured by the second device 120. For example, a configuration of the time period may be contained in the configuration of the first transmission. In this case, the first device 110 may determine whether the at least one monitoring occasion occurs within the time period after the end of SSB transmission. If the at least one monitoring occasion occurs within the time period after the end of SSB transmission, the first device 110 may start monitoring the second transmission during the at least one monitoring occasion.

Alternatively, or additionally, the at least one monitoring occasion may start immediately after a transmission occasion for SSB that is received after the first transmission. In this case, the time period may be equal to 0.

In some example embodiments, the first device 110 may postpone the monitoring occasion to the start of the next active period. For example, in a case that the first transmission is delay tolerant data, the postponement of DL monitoring may be acceptable. In this case, the first device 110 may determine the at least one monitoring occasion during the active period of the DTX pattern.

Additionally, in some example embodiments, the first device 110 may determine which of the next active period and the DL monitoring occasion determined based on the time offset occurs first, and then monitor for the second transmission in the determined earlier one.

In some example embodiments, the time offset may be configured based on a delay characteristic associated with the first transmission. In particular, the delay characteristic may indicate whether the first transmission is tolerant or sensitive to a delay. The delay characteristic may comprise delay tolerant data, and delay sensitive data or delay stringent data. The delay sensitive data has relatively stringent delay requirements, while the delay tolerant data has relatively relaxed delay requirements.

In some example embodiments, the delay sensitive data may be mapped to a specific logical channel (LCH). For example, a configuration for the first transmission may comprise DL monitoring rules per one or more identifiers of LCH (e.g., LCH ID(s)). The DL monitoring rules may include but not limited to:
(i) starting the at least one monitoring occasion occurring during an active period configured for the apparatus and partially or fully overlapped with the non-active period of the DTX pattern;
(ii) starting the at least one monitoring occasion occurring within a time period after a transmission occasion for SSB that is received after the first transmission;
(iii) starting the at least one monitoring occasion occurring immediately after a transmission occasion for SSB that is received after the first transmission;
(iv) starting the at least one monitoring occasion occurring during a next active period of the DTX pattern.

By way of example, if the first transmission is mapped to a specific LCH that corresponds to the delay sensitive data, one or more of the above rules (i) to (iii) may be applicable. If the first transmission is mapped to the remaining LCH(s) that corresponds to the delay tolerant data, then the above rule (iv) may be applicable.

Alternatively, as another example, if the first transmission is mapped to a specific LCH that corresponds to the delay tolerant data, then the above rule (iv) may be applicable. If the first transmission is mapped to remaining LCH(s) that corresponds to the delay sensitive data, one or more of the above rules (i) to (iii) may be applicable.

Additionally, or alternatively, the delay sensitive data may be mapped to specific identification information of the first transmission (e.g., a SR ID in case that the first transmission is SR), or a certain trigger type of the first transmission. For example, the trigger type may comprise but not limited to, triggering the first transmission by listen before talk (LBT) failure, triggering by beam failure recovery (BFR) medium access control (MAC) control element (CE), or other suitable triggering.

It is to be understood that the above-described factors regarding the determination of the delay characteristic may be applied separately, or in any suitable combination. Other factor may also be used for the delay characteristic determination. Scope of the present disclosure is not limited in this regard.

The least one monitoring occasion may correspond to one of a search space specific to the first device 110, or a common search space associated with the second transmission. For example, the search space specific to the first device 110 may have more frequent DL monitoring occasions than the common search space.

In some example embodiments, a configuration of the search space specific to the first device 110 and/or a configuration of the common search space may be configured by the second device 120. For example, the configuration of search space specific to the first device 110 and/or the configuration of the common search space may be transmitted as part of the cell DTX/DRX configuration. Alternatively, the configuration of search space specific to the first device 110 and/or the configuration of the common search space may be configured and transmitted separately from the cell DTX/DRX configuration.

In some example embodiments, the search space may be configured per LCH, per SR, per CG, per DTX configuration, per MAC entity, or per UE.

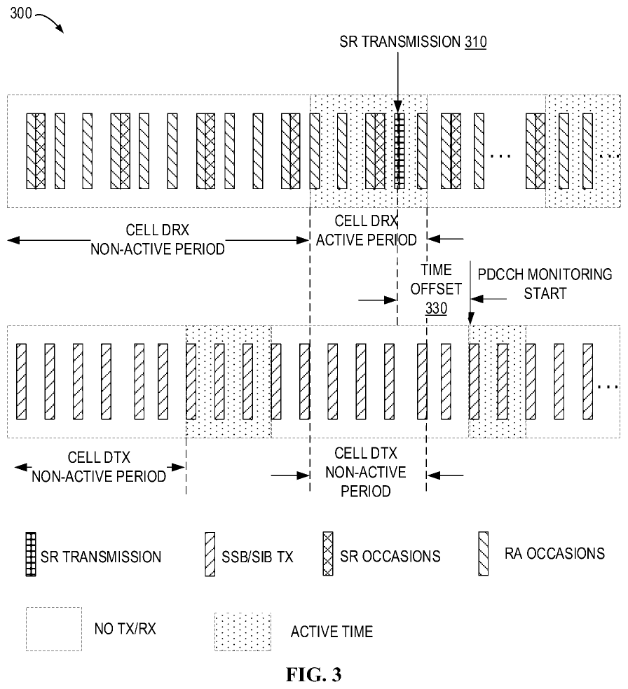

FIG. 3 illustrates a schematic diagram of example DTX and DRX patterns 300 according to some example embodiments of the present disclosure. As depicted, the first transmission such as SR transmission 310 is performed at a slot in an active period of the DRX pattern but a non-active period of the DTX pattern. The time offset 330 is configured by the second device 120. Thus, in the example of FIG. 3, the first device 110 may start performing DL monitoring at a slot after the time offset 330 from the SR transmission 310, which corresponds to an active time.

Examples of determining the DL monitoring occasion by the first device 110 have been described above. It should be understood that from the perspective of the second device 120, the transmission occasion for the second transmission shall be determined based on analogous or same rules with those used by the first device 110.

In some example embodiments, the second device 120 transmits 240, to the first device 110, the second transmission during the at least one occasion.

In some example embodiments, upon transmitting the first transmission, the first device 110 may start a timer for prohibiting retransmission of the first transmission. This is to avoid frequent and unnecessary retransmissions. In one example, the timer may be associated with an extended duration.

In some cases, a larger value may be defined or set for the timer. This may ensure that the first device 110 would not attempt a retransmission of the first transmission after the first transmission that falls in the non-active period of the DTX pattern, due to the delayed response from the second device 120.

Alternatively, or in addition, the timer may be associated with a start time based on a time offset configured by the second device 120. For example, the start time of the timer may correspond to a start time of a first DL monitoring occasion.

Alternatively, or in addition, in some example embodiments, if the first transmission is transmitted during the non-active period of the DTX pattern, the first device 110 may apply a first timer for prohibiting retransmission of the first transmission. In such cases, a second timer for prohibiting retransmission of the first transmission is also configured for applying to the first transmission transmitted during an active period of the DTX pattern. A configuration of the first timer is different from a configuration of the second timer.

The configuration of the first timer and the configuration of the second timer may be received from the second device 120 as part of a configuration of the first transmission.

As discussed above, the first transmission may be different types of transmission. In embodiments where the first transmission is a SR, the second transmission may be an uplink grant. In such cases, the timer may comprise a scheduling request prohibit timer. By way of example, the scheduling request prohibit timer may be sr-ProhibitTimer shown in Table 2 above. sr-ProhibitTimer is a timer for SR transmission on PUCCH in TS 38.321. Value of sr-ProhibitTimer is in ms. Value ms1 corresponds to 1 ms, value ms2 corresponds to 2 ms, and so on. If sr-ProhibitTimer-v1700 is configured, the first device 110 shall ignore sr-ProhibitTimer (without suffix). If both sr-ProhibitTimer (without suffix) and sr-ProhibitTimer-v1700 are absent, the first device 110 may apply the value 0.

In embodiments where the first transmission is a PRACH preamble, the second transmission may be a RAR message. In such cases, the timer may correspond to a RAR window. By way of example, the RAR window may be ra-ResponseWindow as shown in Table 3, which shows an example of configuration of RACH. The IE RACH-ConfigGeneric is used to specify the random-access parameters both for regular random access as well as for beam failure recovery. The ra-ResponseWindow represents a Msg2 (RAR) window length in number of slots. The second device 120 may configure a value lower than or equal to 10 ms when Msg2 is transmitted in licensed spectrum and a value lower than or equal to 40 ms when Msg2 is transmitted with shared spectrum channel access (see TS 38.321 [3], clause 5.1.4). The first device 110 ignores the field if included in SCellConfig. If ra-ResponseWindow-v1610 or ra-ResponseWindow-v1700 is signalled, the first device 110 shall ignore the ra-ResponseWindow (without suffix). The field ra-ResponseWindow-v1700 is applicable to SCS 480 kHz and SCS 960 kHz.

TABLE 3
RACH-ConfigGeneric information element

-- ASN1START
-- TAG-RACH-CONFIGGENERIC-START

| | |
|---|---|
| RACH-ConfigGeneric ::= | SEQUENCE { |
| prach-ConfigurationIndex | INTEGER (0..255), |

| | |
|---|---|
| msg1-FDM | ENUMERATED {one, two, four, eight}, |

| | |
|---|---|
| msg1-FrequencyStart | INTEGER (0..maxNrofPhysicalResourceBlocks-1), |

| | |
|---|---|
| zeroCorrelationZoneConfig | INTEGER(0..15), |

| | |
|---|---|
| preambleReceivedTargetPower | INTEGER (−202..−60), |

| | |
|---|---|
| preambleTransMax | ENUMERATED {n3, n4, n5, n6, n7, n8, n10, n20, n50, n100, n200}, |
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

```
  ...,
  [[
```

| | |
|---|---|
| prach-ConfigurationPeriodScaling-IAB-r16 | ENUMERATED |

| | |
|---|---|
| {scf1,scf2,scf4,scf8,scf16,scf32,scf64} | OPTIONAL, -- Need R |

| | | |
|---|---|---|
| prach-ConfigurationFrameOffset-IAB-r16 | INTEGER (0..63) | OPTIONAL, -- Need |

R

| | | |
|---|---|---|
| prach-ConfigurationSOffset-IAB-r16 | INTEGER (0..39) | OPTIONAL, -- Need R |

| | | |
|---|---|---|
| ra-ResponseWindow-v1610 | ENUMERATED { sl60, sl160} | OPTIONAL, -- Need |

R

| | | |
|---|---|---|
| prach-ConfigurationIndex-v1610 | INTEGER (256..262) | OPTIONAL -- Need R |

```
  ]],
  [[
```

| | |
|---|---|
| ra-Response Window-v1700 | ENUMERATED {sl240, sl320, sl640, sl960, sl1280, sl1920, |

sl2560} OPTIONAL -- Need R
]]
}
-- TAG-RACH-CONFIGGENERIC-STOP
-- ASN1STOP

In embodiments where the first transmission is a CG transmission on PUSCH, the second transmission may be a HARQ feedback or a retransmission grant for the configured grant transmission. In such cases, the timer may be a CG timer such as configuredGrantTimer, a CG retransmission timer such as cg-RetransmissionTimer, or a CG small data transmission retransmission timer such as cg-SDT-RetransmissionTimer.

With the DL monitoring mechanism provided by the example embodiments of the present disclosure, the first device 110, such as UE, is enabled to determine when the cell is able to respond to certain UE transmissions. Thus, DL monitoring can be efficiently performed. Moreover, the first device 110 can determine the appropriate occasion to retransmit the UL transmission in case of no feedback/response received in the monitoring occasions. As a result, signaling or UE energy may be saved, because the UE can avoid unnecessary retransmissions.

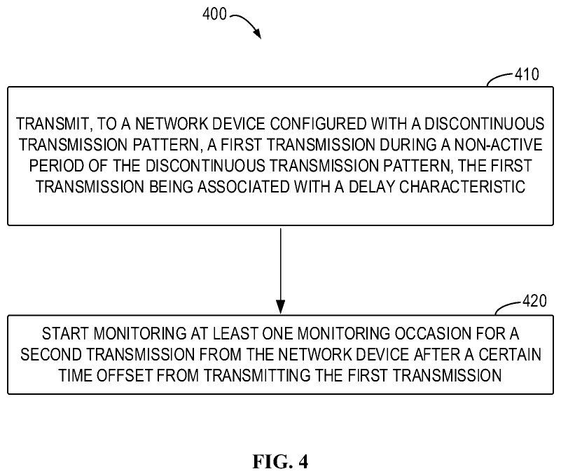

FIG. 4 illustrates a flowchart of a method 400 implemented at an apparatus according to some example embodiments of the present disclosure. For example, the apparatus may be a terminal device, such as, the first device 110 in FIG. 1. For the purpose of discussion, the method 400 will be described from the perspective of the first device 110 in FIG. 1.

At block 410, the apparatus transmits, to a network device configured with a discontinuous transmission pattern, a first transmission during a non-active period of the discontinuous transmission pattern. For example, the network device may be the second device 120 shown in FIG. 1.

At block 420, the apparatus starts monitoring at least one monitoring occasion for a second transmission from the network device after a time offset from transmitting the first transmission.

In some example embodiments, the first transmission may comprise at least one of the following:
a scheduling request, wherein the second transmission comprises an uplink grant,
a physical random access channel preamble, wherein the second transmission comprises a random access response message, or
a configured grant transmission on physical uplink shared channel, wherein the second transmission comprises one of a HARQ feedback or a retransmission grant for the configured grant transmission.

In some example embodiments, the apparatus may be further caused to: receive, from the network device, a configuration of the time offset; and determine that the at least one monitoring occasion starts after the time offset from transmitting the first transmission.

In some example embodiments, the time offset may be configured per logical channel, per scheduling request, per configured grant, per discontinuous transmission configuration, per medium access control (MAC) control element (CE), or per UE.

In some example embodiments, the at least one monitoring occasion may correspond to one of a search space specific to the apparatus, or a common search space associated with the second transmission.

In some example embodiments, the corresponding one of the search space specific to the apparatus or the common search space may be configured by the network device.

In some example embodiments, the at least one monitoring occasion may occur during an active period configured for the apparatus and be partially or fully overlapped with the non-active period of the discontinuous transmission pattern.

In some example embodiments, the at least one monitoring occasion may start within a time period after a transmission occasion for synchronization signal block, SSB that is received after the first transmission.

In some example embodiments, the apparatus may be further caused to: receive, from the network device, a configuration of the time period; determine whether the at least one monitoring occasion occurs within the time period after the end of SSB transmission; and in accordance with the determination that the at least one monitoring occasion occurs within the time period after the end of SSB transmission, start monitoring the second transmission during the at least one monitoring occasion.

In some example embodiments, the at least one monitoring occasion may start immediately after a transmission occasion for synchronization signal block, SSB that is received after the first transmission.

In some example embodiments, a value of the time offset may be associated with a transition time from a sleep state of the network device during the non-active period of the discontinuous transmission pattern to an active state.

In some example embodiments, the at least one monitoring occasion may be during a next active period of the discontinuous transmission pattern.

In some example embodiments, the apparatus may be further caused to: upon transmitting the first transmission, start a timer for prohibiting retransmission of the first transmission, the timer being associated with at least one of the following:
an extended duration, or
a start time based on an offset configured by the network device or a time period after a SSB transmission.

In some example embodiments, the start time of the timer may correspond to a start time of a first physical downlink control channel monitoring occasion.

In some example embodiments, the first transmission may comprise a scheduling request, the second transmission comprises an uplink grant, and the timer comprises a scheduling request prohibit timer.

In some example embodiments, the first transmission may comprise a physical random access channel preamble, the second transmission comprises a random access response message, and the timer corresponds to a random access response window.

In some example embodiments, the first transmission may comprise a configured grant transmission on physical uplink shared channel, the second transmission comprises one of a HARQ feedback or a retransmission grant for the configured grant transmission, and the timer comprises one of a configured grant timer, a configured grant retransmission timer, or a configured grant small data transmission retransmission timer.

In some example embodiments, the apparatus may be further caused to: in accordance with a determination that the first transmission is transmitted during the non-active period of the discontinuous transmission pattern, apply a first timer for prohibiting retransmission of the first transmission, wherein a second timer for prohibiting retransmission of the first transmission is to be applied to the first transmission transmitted during an active period of the discontinuous transmission pattern, and a configuration of the first timer is different from a configuration of the second timer.

In some example embodiments, the configuration of the first timer and the configuration of the second timer may be received from the network device as part of a configuration of the first transmission.

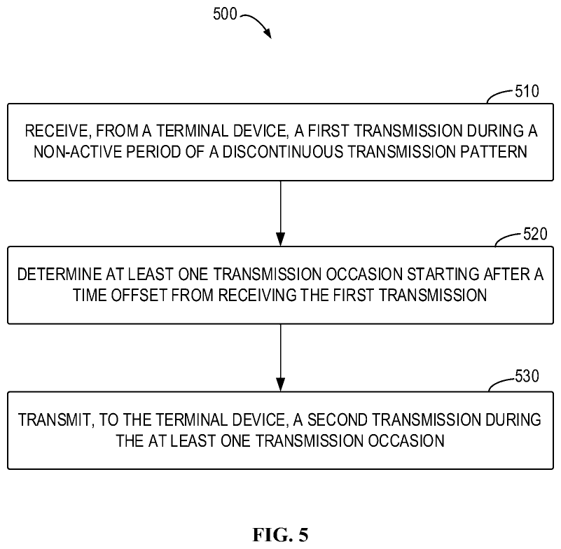

FIG. 5 shows a flowchart of an example method 500 implemented at an apparatus in accordance with some example embodiments of the present disclosure. For example, the apparatus may be a network device, such as, the second device 120 shown in FIG. 1. For the purpose of discussion, the method 500 will be described from the perspective of the second device 120 in FIG. 1.

At block 510, the apparatus receives, from a terminal device, a first transmission during a non-active period of a discontinuous transmission pattern. For example, the terminal device may be the first device 110 shown in FIG. 1.

At block 520, the apparatus determines at least one transmission occasion starting after a time offset from receiving the first transmission.

At block 530, the apparatus transmits, to the terminal device, a second transmission during the at least one transmission occasion.

In some example embodiments, the first transmission may comprise at least one of the following:
a scheduling request, wherein the second transmission comprises an uplink grant,
a physical random access channel preamble, wherein the second transmission comprises a random access response message, or
a configured grant transmission on physical uplink shared channel, wherein the second transmission comprises one of a HARQ feedback or a retransmission grant for the configured grant transmission.

In some example embodiments, the apparatus may be further caused to transmit, to the terminal device, a configuration of the time offset; and determine that the at least one transmission occasion starts after the time offset from receiving the first transmission.

In some example embodiments, the time offset may be configured per logical channel, per scheduling request, per configured grant, per discontinuous transmission configuration, per medium access control (MAC) control element (CE), or per UE.

In some example embodiments, a value of the time offset is determined based on a delay characteristic associated with the first transmission, and the delay characteristic comprises one of delay sensitive data or delay tolerant data.

In some example embodiments, the delay characteristic may be determined based on at least one of the following:
an identifier of a logical channel mapped to the first transmission,
identification information of the first transmission,
a trigger type of the first transmission.

In some example embodiments, the at least one transmission occasion may correspond to one of a search space specific to the terminal device, or a common search space associated with the second transmission.

In some example embodiments, the apparatus may be further caused to: transmit, to the terminal device, a configuration of the corresponding one of the search space specific to the terminal device or the common search space.

In some example embodiments, the at least one transmission occasion may be during an active period configured for the terminal device and be partially or fully overlapped with the non-active period of the discontinuous transmission pattern.

In some example embodiments, the at least one transmission occasion may start immediately after a transmission occasion for synchronization signal block, SSB that is received after the first transmission.

In some example embodiments, the at least one transmission occasion may start within a time period after a transmission occasion for synchronization signal block, SSB that is received after the first transmission.

In some example embodiments, a value of the time offset may be associated with a sleep state of the network device during the non-active period of the discontinuous transmission pattern.

In some example embodiments, the apparatus may be further caused to: transmit, to the terminal device, a configuration of the time period, wherein the terminal device is caused to start monitoring the second transmission during the at least one transmission occasion only if the at least one transmission occasion occurs within the time period after the end of SSB transmission.

In some example embodiments, the at least one transmission occasion may be during a next active period of the discontinuous transmission pattern.

In some example embodiments, the apparatus may be further caused to: transmit, to the terminal device, a configuration of a first timer for prohibiting retransmission of the first transmission and a configuration of a second timer for prohibiting retransmission of the first transmission as part of a configuration of the first transmission, wherein the first timer is to be applied to the first transmission transmitted during the non-active period of the discontinuous transmission pattern, and the second timer is to be applied to the first transmission transmitted during an active period of the discontinuous transmission pattern, the configuration of the first timer is different from the configuration of the second timer.

In some example embodiments, an apparatus, which is also referred to as a first apparatus hereafter, capable of performing any of the method 400 (for example, the first device 110 in FIG. 1) may comprise means for performing the respective operations of the method 400. The means may be implemented in any suitable form. For example, the means may be implemented in a circuitry or software module. The first apparatus may be implemented as or included in the first device 110 in FIG. 1.

In some example embodiments, the first apparatus comprises means for transmitting, to a network device configured with a discontinuous transmission pattern, a first transmission during a non-active period of the discontinuous transmission pattern; and means for starting monitoring at least one monitoring occasion for a second transmission from the network device after a time offset from transmitting the first transmission.

In some example embodiments, the first transmission may comprise at least one of the following:
a scheduling request, wherein the second transmission comprises an uplink grant,
a physical random access channel preamble, wherein the second transmission comprises a random access response message, or
a configured grant transmission on physical uplink shared channel, wherein the second transmission comprises one of a HARQ feedback or a retransmission grant for the configured grant transmission.

In some example embodiments, the first apparatus may further comprise: means for receiving, from the network device, a configuration of the time offset; and means for determining that the at least one monitoring occasion starts after the time offset from transmitting the first transmission.

In some example embodiments, the time offset may be configured per logical channel, per scheduling request, per configured grant, per discontinuous transmission configuration, per medium access control (MAC) control element (CE), or per UE.

In some example embodiments, the at least one monitoring occasion may correspond to one of a search space specific to the first apparatus, or a common search space associated with the second transmission.

In some example embodiments, the corresponding one of the search space specific to the first apparatus or the common search space may be configured by the network device.

In some example embodiments, the at least one monitoring occasion may occur during an active period configured for the first apparatus and be partially or fully overlapped with the non-active period of the discontinuous transmission pattern.

In some example embodiments, the at least one monitoring occasion may start within a time period after a transmission occasion for synchronization signal block, SSB that is received after the first transmission.

In some example embodiments, the first apparatus may further comprise: means for receiving, from the network device, a configuration of the time period; means for determining whether the at least one monitoring occasion occurs within the time period after the end of SSB transmission; and means for in accordance with the determination that the at least one monitoring occasion occurs within the time period after the end of SSB transmission, starting monitoring the second transmission during the at least one monitoring occasion.

In some example embodiments, the at least one monitoring occasion may start immediately after a transmission occasion for synchronization signal block, SSB that is received after the first transmission.

In some example embodiments, a value of the time offset may be associated with a transition time from a sleep state of the network device during the non-active period of the discontinuous transmission pattern to an active state.

In some example embodiments, the at least one monitoring occasion may be during a next active period of the discontinuous transmission pattern.

In some example embodiments, the first apparatus may further comprise: means for upon transmitting the first transmission, starting a timer for prohibiting retransmission of the first transmission, the timer being associated with at least one of the following:
an extended duration, or
a start time based on an offset configured by the network device or a time period after a SSB transmission.

In some example embodiments, the start time of the timer may correspond to a start time of a first physical downlink control channel monitoring occasion.

In some example embodiments, the first transmission may comprise a scheduling request, the second transmission comprises an uplink grant, and the timer comprises a scheduling request prohibit timer.

In some example embodiments, the first transmission may comprise a physical random access channel preamble, the second transmission comprises a random access response message, and the timer corresponds to a random access response window.

In some example embodiments, the first transmission may comprise a configured grant transmission on physical uplink shared channel, the second transmission comprises one of a HARQ feedback or a retransmission grant for the configured grant transmission, and the timer comprises one of a configured grant timer, a configured grant retransmission timer, or a configured grant small data transmission retransmission timer.

In some example embodiments, the first apparatus may further comprise: means for in accordance with a determination that the first transmission is transmitted during the non-active period of the discontinuous transmission pattern, applying a first timer for prohibiting retransmission of the first transmission, wherein a second timer for prohibiting retransmission of the first transmission is to be applied to the first transmission transmitted during an active period of the discontinuous transmission pattern, and a configuration of the first timer is different from a configuration of the second timer.

In some example embodiments, the configuration of the first timer and the configuration of the second timer may be received from the network device as part of a configuration of the first transmission.

In some example embodiments, an apparatus, also referred to as a second apparatus, capable of performing any of the method 500 (for example, the second device 120 in FIG. 1) may comprise means for performing the respective operations of the method 500. The means may be implemented in any suitable form. For example, the means may be implemented in a circuitry or software module. The second apparatus may be implemented as or included in the second device 120 in FIG. 1.

In some example embodiments, the second apparatus comprises means for receiving, from a terminal device, a first transmission during a non-active period of a discontinuous transmission pattern; means for determining at least one transmission occasion starting after a time offset from receiving the first transmission; and means for transmitting, to the terminal device, a second transmission during the at least one transmission occasion.

In some example embodiments, the first transmission may comprise at least one of the following:
a scheduling request, wherein the second transmission comprises an uplink grant,
a physical random access channel preamble, wherein the second transmission comprises a random access response message, or
a configured grant transmission on physical uplink shared channel, wherein the second transmission comprises one of a HARQ feedback or a retransmission grant for the configured grant transmission.

In some example embodiments, the second apparatus may further comprise:
means for transmitting, to the terminal device, a configuration of the time offset; and means for determining that the at least one transmission occasion starts after the time offset from receiving the first transmission.

In some example embodiments, the time offset is configured per logical channel, per scheduling request, per configured grant, per discontinuous transmission configuration, per medium access control (MAC) control element (CE), or per UE.

In some example embodiments, a value of the time offset is determined based on a delay characteristic associated with the first transmission, and the delay characteristic comprises one of delay sensitive data or delay tolerant data.

In some example embodiments, the delay characteristic may be determined based on at least one of the following:
an identifier of a logical channel mapped to the first transmission,
identification information of the first transmission,
a trigger type of the first transmission.

In some example embodiments, the at least one transmission occasion may correspond to one of a search space specific to the terminal device, or a common search space associated with the second transmission.

In some example embodiments, the second apparatus may further comprise:

means for transmitting, to the terminal device, a configuration of the corresponding one of the search space specific to the terminal device or the common search space.

In some example embodiments, the at least one transmission occasion may be during an active period configured for the terminal device and be partially or fully overlapped with the non-active period of the discontinuous transmission pattern.

In some example embodiments, the at least one transmission occasion may start immediately after a transmission occasion for synchronization signal block, SSB that is received after the first transmission.

In some example embodiments, the at least one transmission occasion may start within a time period after a transmission occasion for synchronization signal block, SSB that is received after the first transmission.

In some example embodiments, a value of the time offset may be associated with a sleep state of the network device during the non-active period of the discontinuous transmission pattern.

In some example embodiments, the second apparatus may further comprise: means for transmitting, to the terminal device, a configuration of the time period, wherein the terminal device is caused to start monitoring the second transmission during the at least one transmission occasion only if the at least one transmission occasion occurs within the time period after the end of SSB transmission.

In some example embodiments, the at least one transmission occasion may be during a next active period of the discontinuous transmission pattern.

In some example embodiments, the second apparatus may further comprise: means for transmitting, to the terminal device, a configuration of a first timer for prohibiting retransmission of the first transmission and a configuration of a second timer for prohibiting retransmission of the first transmission as part of a configuration of the first transmission, wherein the first timer is to be applied to the first transmission transmitted during the non-active period of the discontinuous transmission pattern, and the second timer is to be applied to the first transmission transmitted during an active period of the discontinuous transmission pattern, the configuration of the first timer is different from the configuration of the second timer.

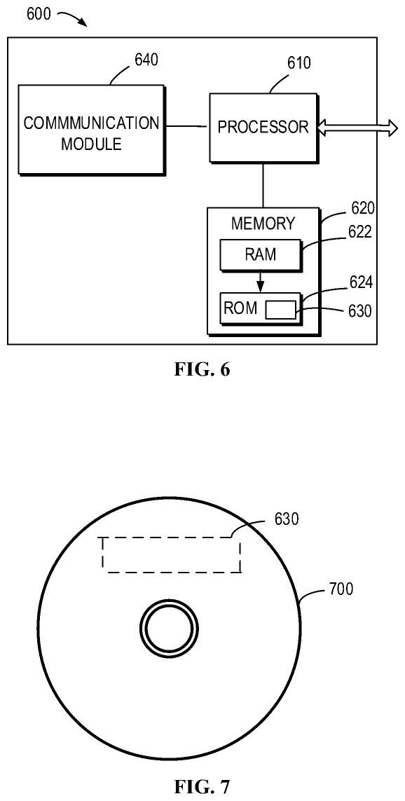

FIG. 6 is a simplified block diagram of a device 600 that is suitable for implementing example embodiments of the present disclosure. The device 600 may be provided to implement a communication device, for example, the first device 110, or the second device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-39. (canceled)

40. An apparatus comprising:
at least one processor; and
at least one memory storing instructions that, when executed by the at least one processor, cause the apparatus to perform the following operations:
transmitting, to a network device operating according to a cell-level discontinuous transmission (DTX) pattern, a scheduling request on an uplink control channel during a non-active period of the discontinuous transmission pattern;
receiving, from the network device, a configuration indicating a time offset associated with a transition time of the network device from a sleep state to an active state during the non-active period of the discontinuous transmission pattern;
determining, based on the configured time offset, a first downlink monitoring occasion that starts after the time offset and that occurs within a configured time period following reception of a synchronization signal block (SSB);
monitoring a physical downlink control channel only during the determined first downlink monitoring occasion, wherein the first downlink monitoring occasion corresponds to a search space specific to the apparatus; and
upon transmitting the scheduling request during the non-active period of the discontinuous transmission pattern, starting a scheduling-request prohibit timer having a duration different from a scheduling-request prohibit timer applied to scheduling requests transmitted during an active period of the discontinuous transmission pattern, wherein the second transmission comprises an uplink grant transmitted by the network device during the determined first downlink monitoring occasion.

41. The apparatus of claim 40, wherein the configured time offset is expressed in a number of slots and is greater than a transition time associated with a light-sleep state of the network device.

42. The apparatus of claim 41, wherein the configured time offset is received as part of a cell discontinuous transmission configuration transmitted by the network device.

43. The apparatus of claim 42, wherein the scheduling request is mapped to a logical channel identifier corresponding to delay-sensitive data, and wherein determining the first downlink monitoring occasion is based on the logical channel identifier.

44. The apparatus of claim 43, wherein the first downlink monitoring occasion starts immediately after reception of the synchronization signal block that is first received after transmitting the scheduling request.

45. The apparatus of claim 44, wherein the configured time period following reception of the synchronization signal block is equal to zero slots.

46. The apparatus of claim 45, wherein monitoring the physical downlink control channel comprises monitoring only during the first downlink monitoring occasion and refraining from monitoring during any earlier downlink control channel monitoring occasions falling within the non-active period of the discontinuous transmission pattern.

47. The apparatus of claim 46 wherein the search space specific to the apparatus is configured per scheduling request identifier.

48. The apparatus of claim 47, wherein the scheduling-request prohibit timer is started at a beginning of the first downlink monitoring occasion rather than at transmission of the scheduling request.

49. The apparatus of claim 48, wherein the scheduling-request prohibit timer applied to scheduling requests transmitted during the non-active period of the discontinuous transmission pattern has a longer duration than the scheduling-request prohibit timer applied to scheduling requests transmitted during the active period of the discontinuous transmission pattern.

50. A method performed by an apparatus, the method comprising:
transmitting, to a network device operating according to a cell-level discontinuous transmission (DTX) pattern, a scheduling request on an uplink control channel during a non-active period of the discontinuous transmission pattern;
receiving, from the network device, a configuration indicating a time offset associated with a transition time of the network device from a sleep state to an active state during the non-active period of the discontinuous transmission pattern;
determining, based on the configured time offset, a first downlink monitoring occasion that starts after the time offset and that occurs within a configured time period following reception of a synchronization signal block (SSB);
monitoring a physical downlink control channel only during the determined first downlink monitoring occasion, wherein the first downlink monitoring occasion corresponds to a search space specific to the apparatus; and
upon transmitting the scheduling request during the non-active period of the discontinuous transmission pattern, starting a scheduling-request prohibit timer having a duration different from a scheduling-request prohibit timer applied to scheduling requests transmitted during an active period of the discontinuous transmission pattern, wherein the second transmission comprises an uplink grant transmitted by the network device during the determined first downlink monitoring occasion.

51. The method of claim 50, wherein the configured time offset is expressed in a number of slots and is greater than a transition time associated with a light-sleep state of the network device.

52. The method of claim 51, wherein the configured time offset is received as part of a cell discontinuous transmission configuration transmitted by the network device.

53. The method of claim 52, wherein the scheduling request is mapped to a logical channel identifier corresponding to delay-sensitive data, and wherein determining the first downlink monitoring occasion is based on the logical channel identifier.

54. The method of claim 53, wherein the first downlink monitoring occasion starts immediately after reception of the synchronization signal block that is first received after transmitting the scheduling request.

55. The method of claim 54, wherein the configured time period following reception of the synchronization signal block is equal to zero slots.

56. The method of claim 55, wherein monitoring the physical downlink control channel comprises monitoring only during the first downlink monitoring occasion and refraining from monitoring during any earlier downlink control channel monitoring occasions falling within the non-active period of the discontinuous transmission pattern.

57. The method of claim 56 wherein the search space specific to the apparatus is configured per scheduling request identifier.

58. The method of claim 57, wherein the scheduling-request prohibit timer is started at a beginning of the first downlink monitoring occasion rather than at transmission of the scheduling request.

59. The method of claim 58, wherein the scheduling-request prohibit timer applied to scheduling requests transmitted during the non-active period of the discontinuous transmission pattern has a longer duration than the scheduling-request prohibit timer applied to scheduling requests transmitted during the active period of the discontinuous transmission pattern.
